(19) United States
(12) Patent Application Publication
(10) Pub. No.: US 2003/0057202 A1
(43) Pub. Date: Mar. 27, 2003

(54) Shrink set tool presetter/induction heating unit machine, and adaptor therefor

(76) Inventor: Leslie D. Maxson, Millington, MI (US)

Correspondence Address: Irving M. Weiner, 635 N. US-23, P.O. Box 186, Harrisville, MI, 48740, US

(21) Appl. No.: 10/253,004

(22) Filed: Sep. 23, 2002

Related U.S. Application Data
(60) Provisional application No. 60/324,598, filed on Sep. 24, 2001.

(51) Int. Cl. H05B 6/10

(52) U.S. Cl. 219/635; 219/647; 219/602

(57) ABSTRACT

An adaptor for combing a shrink preset tool presetting machine with an induction heating unit. The adaptor is disposed at the bottom of the induction slide member of the induction heating unit and is fastened around the outer periphery of the preset spindle device of the shrink set tool presetting machine. The combined shrink set tool presetter/induction heating machine assembly is also provided with a novel fine adjustment mechanism.

The present patent application claims priority from U.S. Provisional Patent Application Serial No. 60/324,598 filed Sep. 24, 2001.

### BACKGROUND OF THE INVENTION

The present invention relates generally to a combined shrink set tool presetter/induction heating machine assembly, and an adaptor therefor.

More particularly, the present invention relates to a machine mentioned hereinabove for measuring and shrinking tools in a preset spindle, regardless of what preset model or shrinker unit is employed.

Even more particularly, the present invention relates to the machine as mentioned hereinabove including the use of a rod to fine adjust the shrinker tool in the spindle, regardless of how the rod is moved per application.

The prior art is exemplified by Bohler et al. U.S. Pat. No. 6,048,144 entitled “TEMPERATURE INSERTION SPINDLE”, and Graf U.S. Pat. No. 6,061,917 entitled “TOOL PRESETTING DEVICE.”

The present invention provide a machine as mentioned hereinabove which is provided with a novel fine adjust mechanism.

Another aspect of the present invention relates to a machine as mentioned hereinabove, which is provided with a novel adaptor for combining an induction heating unit with a tool presetter.

### SUMMARY OF THE INVENTION

The present invention provides a combined shrink set tool presetting machine and induction heating unit and an adaptor therefor, comprising: a shrink set tool presetting machine; an induction heating unit; said shrink set tool presetting machine includes a preset spindle device; said induction heating unit includes an induction slide member; an adaptor contiguous with a predetermined portion of said induction slide member; and said adaptor being fastenable around the outer periphery of said preset spindle device of said shrink set tool presetting machine.

The present invention also provides a novel and unique adaptor mechanism for combining a shrink set tool presetting machine with an induction heating unit, comprising: an induction slide member forming part of said induction heating unit; said adaptor mechanism being operably connected with said induction slide member of said induction heating unit; said shrink set tool presetting machine including a preset spindle device; and said adaptor mechanism being fastened around the outer periphery of said preset spindle device of said shrink set tool presetting machine.

### BRIEF DESCRIPTION OF THE SEVERAL VIEWS OF THE DRAWINGS

FIG. 1 is a front elevational view of the combined shrink set tool presetter/induction heating unit machine in accordance with a preferred embodiment of the present invention.

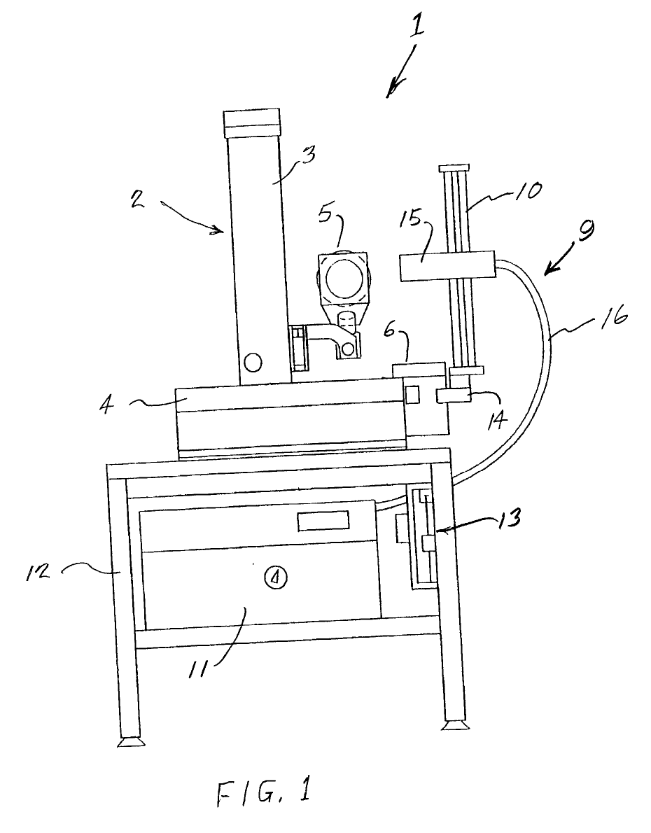

FIG. 2 is a schematic drawing of various sections of components of the machine illustrated in FIG. 1, which depicts further details of the novel adaptor and fine adjust mechanism in accordance with the present invention.

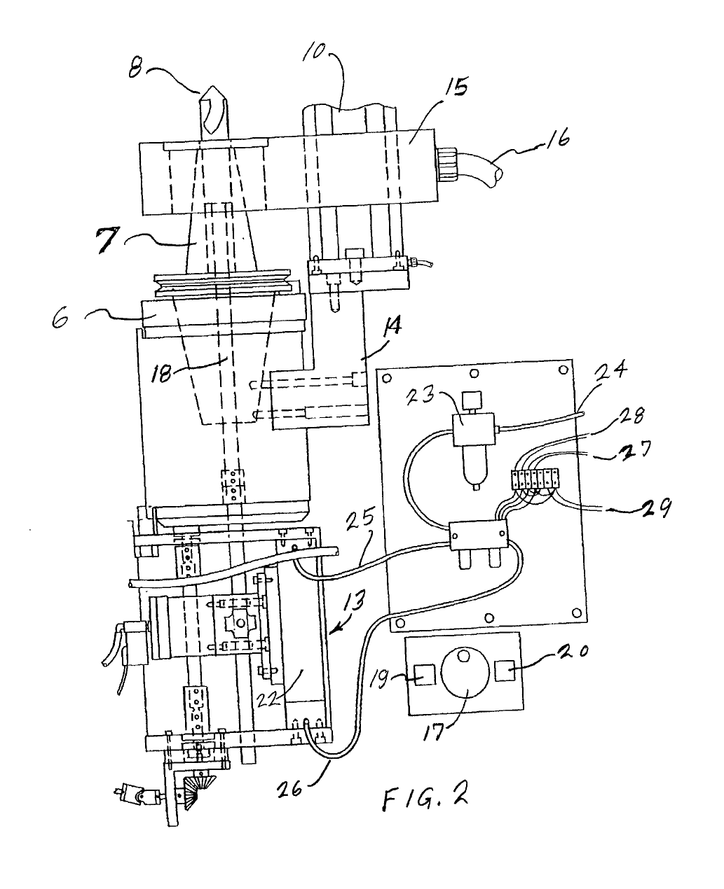

### DETAILED DESCRIPTION OF THE INVENTION

The accompanying drawings illustrate the combined shrink set tool presetter/induction heating unit machine 1 in accordance with the present invention.

The main components include the tool presetter machine2, the preset column 3, the preset base4, the preset projector 5, the preset spindle 6, the tool holder 7, the cutting tool 8, the induction heating unit 9, the induction slide member 10, the induction heating unit power supply 11, the cabinet 12, the fine adjust mechanism 13, the novel adaptor 14, the induction heating head 15, the induction cable 16, and the fine adjust knob 17

The tool presetting machine 2 includes the preset spindle 6 for rotatably holding the tool holder 7 and tool 8. The tool 8 is received in the tool holder 7 which defines an axis wherein the tool 8 is enabled to be rotated in a desired measuring and setting position.

The present invention may perhaps best be understood by explaining a typical sequence of steps of actually using the novel machine 1 in accordance with the present invention.

To begin setting the shrink fit tooling, an adjustment rod 18 is first brought to its highest position by pushing the UP button 19.

Next, the handle that locks the rod 18 in place should then be loosened, and the rod 18 should be adjusted to approximately the length of the tool holder 7 without the cutting tool 8 therein.

Then, the rod 18 should be locked in place again using the handle. If necessary, this might be an appropriate time to change the rod 18, depending on the particular tool size involved.

Then, the rod 18 is moved to its lowest position by pushing the DOWN button 20. This permits the tool holder 7 to be loaded.

Next, the tool holder 7 is positioned into the spindle 6. If necessary, at this point, any coolant tubes and/or retention knobs should be guided over the adjustment rod 18.

To assist in holding the tool 8 in the spindle 6, while changing the tool 8, the vacuum clamping button (not shown) should be pushed. This vacuum clamping feature is optional.

Next, the tool edge should be aligned with the projector 5 by moving the column 3 with the handle. When this has been accomplished, the fine adjustment knob 17 should be used to place the tool edge on the projector cross hairs.

Next, a suitable control, such as, for example, a DPS320 control, should be used to check the measurement of the cutting tool 8 or use the control to set the length to zero.

Next, the UP button 19 should be employed in order to bring the adjustment rod 18 upwardly until it stops against the bottom of the cutting tool 8. This will prevent the cutting tool 8 from falling downwardly out of the bottom of the tool holder 7 when the induction heating is applied. In addition, this also serves as a reference or starting point for the new tool 8 to be installed.

Prior to heating the tool holder 7 with the induction heating unit 9 in order to remove the old tool, it is advisable to have the replacement tool and a heat resistant glove ready because the old tools will be very hot.

Next, the heating time should be adjusted in order to remove the tool 8.

When the operator is ready to remove the tool 8, the start button should be pushed. At this point, the induction heating unit 9 will come down automatically over the tool 8 and return to the top position when finished heating the tool holder 7.

The operator will then use the heat resistant glove to remove the hot tool 8 from the tool holder 7. Preferably, but not necessarily, the hot tool 8 should be put into a heat resistant container or pan.

Next, a new cutting tool 8 should be inserted. The new cutting tool 8 should be pushed downwardly until it makes contact with the adjustment rod 18.

At this point, the fine adjustment knob 17 should be used to move the tool 8 upwardly or downwardly to the cross hairs in the projector 5. It is necessary to do this prior to cooling down of tool 8.

Next, the tool 8 should be adjusted to the cross hairs in the projector 5. When the tool 8 has been adjusted to the cross hairs in the projector 5, cold air may be used to quickly cool the tool holder 7 to grab the cutting tool 8.

At this point, the aforementioned control, such as the DPS320 control, should be checked for correct reading of the tool dimensions.

For removing the hot tool 8 from the spindle 6, the vacuum clamping (if used) should be unclamped. The DOWN button 20 should be pushed to lower the adjustment rod 18. The hot tool 8 should be removed from the spindle 6 using the heat resistant glove. Then, the tool 8 should be placed into a designated rack for cooling.

The foregoing explains a typical sequence for using the machine 1 in accordance with the present invention.

It should be appreciated that the present invention provides the benefits of induction heating the tool holder 7 and shrink-fitting a cold tool 8 with a very close interference fit. Moreover, the concentricity of shrink-fitting a cutting tool is consistently ten thousands of an inch or better. In addition, there are improvements in balance and providing excellent rigidity for the tool 8 and tool holder 7.

The foregoing derives from the fact that the tool holder 7 is induction heated and expanded. Upon cooling, a significant gripping force is applied to the tool 8 which has been inserted into the tool holder 7.

The machine 1 in accordance with the present invention may be employed for on and off shrinking of various tools 8 in suitable tool holders 7. This is accomplished by using induction heating of the tool holder 7 with the aid of the shrinking unit.

The aforementioned features and operations are facilitated by using the novel adaptor 14 and fine adjust mechanism 13 in accordance with the present invention.

The fine adjust mechanism 13 works in conjunction with an air slide 22, a regulator 23, the fine adjust knob 17, the UP button 19, the DOWN button 20, an incoming air line 24 (60-80 psi), a DOWN air line 25, an UP air line 26, DOWN electric lines 27, UP electric lines 28, and cylinder electric lines 29.

In accordance with a preferred embodiment of the present invention, the presetting machine 2 employed was a TSD-Gildemeister machine, which can be used for presetting lengths and diameters.

Again, in accordance with a preferred embodiment of the present invention, the induction heating unit 9 employed was manufactured by GEWEFA Josef C. Pheister. The novel adaptor 14 in accordance with the present invention facilitates the combining of the induction heating unit 9 with the presetting machine 2.

It should be noted that the adaptor 14, which is disposed at the bottom of the induction slide member 10, is fastened around the outer periphery of the preset spindle device. It should also be noted that the shrinking unit switches off automatically after the set shrinking time has expired. The heat expansion of the tool holder 7 permits the shaft of the tool 8 to be inserted. The tool holder 7 and the tool 8 placed therewithin form a shrunken fit after the tool holder 7 has cooled down. This secures the tool 8 from offsetting, twisting and the like.

While the present invention has been illustrated and described in detail in the drawings and the foregoing description, the same is to be considered as illustrative and not restrictive in character, it being understood that only the preferred embodiment has been shown and described fully, and further that all changes and modifications that come within the spirit of the invention are desired to be protected.

1. A combined shrink set tool presetting machine and an induction heating unit and an adaptor therefor, comprising:
a shrink set tool presetting machine;
an induction heating unit;
said shrink set tool presetting machine includes a preset spindle device;
said induction heating unit includes an induction slide member;
an adaptor contiguous with a predetermined portion of said induction slide member; and
said adaptor being fastenable around the outer periphery of said preset spindle device of said shrink set tool presetting machine.

2. The invention as set forth in claim 1, wherein:
said adaptor is disposed at the bottom of said induction slide member of said induction heating unit.

3. The invention as set forth in claim 1, wherein:
said shrink set presetting machine includes a preset spindle, a tool holder, a cutting tool, and an adjustment rod;
there is provided a fine adjustment mechanism operably connected with said shrink set tool presetting machine; and
said fine adjusting mechanism is operably connected with said adjustment rod to fine adjust said cutting tool in said preset spindle.

4. The invention as set forth in claim 2, wherein:
said shrink set presetting machine includes a preset spindle, a tool holder, a cutting tool, and an adjustment rod;
there is provided a fine adjustment mechanism operably connected with said shrink set tool presetting machine; and
said fine adjusting mechanism is operably connected with said adjustment rod to fine adjust said cutting tool in said preset spindle.

5. The invention as set forth in claim 1, wherein:
said adaptor combines said shrink set tool presetting machine with said induction heating unit.

6. The invention as set forth in claim 2, wherein:
said adaptor combines said shrink set tool presetting machine with said induction heating unit.

7. The invention as set forth in claim 3, wherein:
said adaptor combines said shrink set tool presetting machine with said induction heating unit.

8. The invention as set forth in claim 4, wherein:
said adaptor combines said shrink set tool presetting machine with said induction heating unit.

9. An adaptor mechanism for combining a shrink set tool presetting machine with an induction heating unit, comprising:
an induction slide member forming part of said induction heating unit;
said adaptor mechanism being operably connected with said induction slide member of said induction heating unit;
said shrink set tool presetting machine including a preset spindle device; and
said adaptor mechanism being fastened around the outer periphery of said preset spindle device of said shrink set tool presetting machine.

10. The adaptor mechanism according to claim 9, wherein:
said adaptor mechanism is contiguous with a predetermined position of said induction slide member.

11. The adaptor mechanism according to claim 9, wherein:
said adaptor mechanism is disposed at the bottom of said induction slide member of said induction heating unit.

12. The adaptor mechanism according to claim 10, wherein:
said adaptor mechanism is disposed at the bottom of said induction slide member of said induction heating unit.
